(19) United States
(12) Patent Application Publication
(10) Pub. No.: US 2019/0181427 A1
(43) Pub. Date: Jun. 13, 2019

(54) ANODE COMPOSITION, METHOD FOR PREPARING ANODE AND LITHIUM ION BATTERY

(71) Applicant: Robert Bosch GmbH, Stuttgart (DE)

(72) Inventors: Jun Yang, Shanghai (CN); Yitian Bie, Shanghai (CN); Jingjun Zhang, Shanghai (CN); Yuqian Dou, Shanghai (CN); Lei Wang, Shanghai (CN); Qiang Lu, Shanghai (CN); Xiaogang Hao, Shanghai (CN); Rongrong Jiang, Shanghai (CN)

(73) Assignee: Robert Bosch GmbH, Robert Bosch GmbH (DE)

(21) Appl. No.: 16/310,614

(22) PCT Filed: Jun. 15, 2016
(86) PCT No.: PCT/CN2016/085901

§ 371 Date: Dec. 17, 2018

(51) Int. Cl. H01M 4/134; H01M 4/1395; H01M 4/38; H01M 4/62; H01M 10/0525; H01M 10/44; H01M 10/058; H01M 4/04; H01M 10/0569

(52) U.S. Cl. CPC H01M 4/134; H01M 4/1395; H01M 4/386; H01M 4/622; H01M 10/0525; H01M 2010/4292; H01M 10/058; H01M 4/0447; H01M 4/625; H01M 10/0569; H01M 4/0404; H01M 10/446

(57) ABSTRACT

Provided is an anode composition for lithium ion batteries, comprising a) a silicon-based active material; b) a carboxyl-containing binder; and c) a silane coupling agent. Also provided are a process for preparing an anode for lithium ion batteries and a lithium ion battery.

### TECHNICAL FIELD

The present invention relates to an anode composition for lithium ion batteries, a process for preparing an anode for lithium ion batteries, and a lithium ion battery.

### BACKGROUND

Lithium ion batteries have now been widely used in energy storage systems and electric vehicles.

Silicon is a promising active material for electrodes of lithium ion batteries owning to its large theoretical capacity and moderate operating voltage. However, during the lithiation/delithiation processes, silicon undergoes dramatic expansion and contraction. Such huge volumetric change impairs the electrochemical performances of lithium ion batteries.

There is an on-going demand for more attractive and reliable lithium ion batteries.

On the other hand, in the effort to design a high-power battery, the reduction of active material particle size to nano-scale can help shorten the diffusion length of charge carriers, enhance the Li-ion diffusion coefficient, and therefore achieve faster reaction kinetics. However, nano-sized active materials have a large surface area, which results in a high irreversible capacity loss due to the formation of a solid electrode interface (SEI). For silicon oxide based anode, the irreversible reaction during the first lithiation also leads to a large irreversible capacity loss in initial cycle. This irreversible capacity loss consumes Li in the cathode, which decreases the capacity of the full cell.

Even worse, for Si-based anode, repeated volume change during cycling reveals more and more fresh surface on the anode, which leads to continuous growth of SEI. And the continuous growth of SEI continuously consumes Li in the cathode, which results in capacity decay for the full cell.

In order to provide more lithium ions to compensate for an SEI or other lithium consumption during the formation, additional or supplementary Li may be provided by the prelithiation of the anode. If the prelithiation of the anode is conducted, the irreversible capacity loss could be compensated in advance instead of Li consumption from the cathode. This results in higher efficiency and capacity of the cell.

However, a pre-lithiation degree of exact compensation for the irreversible loss of lithium from the anode doesn't help to solve the problem of Li consumption from the cathode during cycling. Therefore, in this case, the cycling performance will not be improved. To compensate for the loss of lithium from the cathode during cycling, an over-prelithiation is conducted in the present invention.

### SUMMARY OF THE INVENTION

After intensive study, the inventors have now developed a novel anode composition for lithium ion batteries, comprising:
a) a silicon-based active material;
b) a carboxyl-containing binder;
c) a silane coupling agent represented by the following formula (1):

Y—(CH₂)ₙ—Si—X3 (1)
wherein Y represents a non-hydrolytic group that is capable of forming a conductive polymer moiety upon polymerization;
X each independently represents a hydroxyl group, or a hydrolysable group selected from the group consisting of halogen atoms, alkoxy groups, ether groups and siloxy groups; and the three X groups may be identical with or different from each other; and
n represents an integer from 0 to 3.

Optionally, the anode composition according to the present disclosure may further comprise: d) a carbon material, wherein the carbon material may be selected from the group consisting of carbon black, super P, acetylene black, Ketjen black, graphite, graphene, carbon nanotubes and vapour grown carbon fibers.

Optionally, the anode composition according to the present disclosure may further comprise: e) a chain extender, which copolymerizes with the conductive polymer moiety obtainable from the silane coupling agent. Preferably, the chain extender may be selected from the group consisting of aniline, pyrrole, thiophene and their derivatives.

In some examples, the anode composition according to the present disclosure may comprise:
a) from 5% to 85% by weight of the silicon-based active material;
b) from 5% to 25% by weight of the carboxyl-containing binder;
c) the silane coupling agent;
d) from 0 to 80% by weight of the carbon material; and
e) from 0 to 30% by weight of the chain extender,
wherein the weight percents of components a), b), d) and e) are based on the total weight of the anode composition, and preferably,
the weight ratio of the silane coupling agent to the silicon-based active material is no less than 0.01:100 but less than 3:100.

Also provided is a process for preparing an anode, comprising:
preparing a slurry by mixing all components of the anode composition according to the present disclosure with water or a water-containing solvent;
allowing the silane coupling agent to polymerize so as to obtain a polymerized product; and
coating the polymerized product onto a current collector.

Also provided is a lithium ion battery, comprising an anode prepared from the anode composition according to the present disclosure, or an anode prepared by the process according to the present disclosure.

Surprisingly, the inventors found that by employing the anode composition according to the present invention, the lithium ion battery exhibits excellent electrochemical properties, including cycling performance and rate performance.

These and other features, aspects and advantages of the present disclosure will become evident to those skilled in the art from the following description of various examples taken in conjunction with the accompanying drawings.

### BRIEF DESCRIPTION OF THE DRAWINGS

FIG. 1 schematically illustrates a presumed bonding mechanism of an anode composition not comprising a silane coupling agent.

FIG. 2 compares cycling performances of cells prepared according to an Example according to the present disclosure and some Comparative Examples.

FIG. 3 compares discharge/charge profiles of cells prepared according to an Example according to the present disclosure and some Comparative Examples.

FIG. 4 compares cycling performances of cells prepared according to some Examples according to the present disclosure and some Comparative Examples.

FIG. 5 compares cycling performances of cells prepared according to some Examples according to the present disclosure and a Comparative Example.

FIG. 6 shows the cycling performances of the full cells of Example P1-E1.

FIG. 7 shows the normalized energy densities of the full cells of Example P1-E1.

FIG. 8 shows the cycling performances of the full cells of Example P1-E2.

FIG. 9 shows the normalized energy densities of the full cells of Example P1-E2.

FIG. 10 shows the cycling performances of the full cells of Example P1-E3 with the prelithiation degrees ε of a) 0 and b) 22%.

FIG. 11 shows the discharge/charge curve of the cell of Comparative Example P2-CE1, wherein “1”, “4”, “50” and “100” stand for the 1^{st}, 4^{th}, 50^{th} and 100^{th} cycle respectively.

FIG. 12 shows the discharge/charge curve of the cell of Example P2-E1, wherein “1”, “4”, “50” and “100” stand for the 1^{st}, 4^{th}, 50^{th} and 100^{th} cycle respectively.

FIG. 13 shows the cycling performances of the cells of a) Comparative Example P2-CE1 (dashed line) and b) Example P2-E1 (solid line).

FIG. 14 shows the average charge voltage a) and the average discharge voltage b) of the cell of Comparative Example P2-CE1.

FIG. 15 shows the average charge voltage a) and the average discharge voltage b) of the cell of Example P2-E1.

Reference will now be made to some illustrative examples, and specific language will be used herein to describe the same. It will nevertheless be understood that no limitation of the scope of the disclosure is thereby intended.

### DETAILED DESCRIPTION OF THE INVENTION

Throughout this disclosure, all the scientific and technical terms, unless otherwise indicated, shall have the same meanings as those known to a person skilled in the art. Where there is inconsistency, the definition provided in the present disclosure should be taken.

It should be understood that the detailed description of all materials, processes, examples and drawings are presented for the purposes of illustration, and therefore, unless expressly specified otherwise, are not construed as limitations of the present disclosure.

Herein, the terms “cell” and “battery” may be interchangeably used. The terms “lithium ion cell” or “lithium ion battery” may also be abbreviated to “cell” or “battery”.

Herein, the term “comprising” means that other ingredients or other steps which do not affect the final effect can be included. This term encompasses the terms “consisting of” and “consisting essentially of”. The product and process according to the present disclosure can comprise, consist of, and consist essentially of the essential technical features and/or limitations of the present disclosure described herein, as well as any additional and/or optional ingredients, components, steps, or limitations described herein.

The use of the terms “a”, “an” and “the” and similar referents in the context of describing the subject matter of this application (especially in the context of the following claims) are to be construed to cover both the singular and the plural, unless otherwise indicated herein or clearly contradicted by context.

Unless otherwise specified, every numerical range in this context intends to include both endpoints and any numbers and sub-ranges falling within said numerical ranges.

Unless specially indicated, all materials and agents used in the present disclosure are commercially available.

Examples of the present disclosure are described in detail as follows.

### Component a): Silicon-Based Active Material

According to some examples of the present disclosure, the anode composition for lithium ion batteries may comprise a silicon-based active material. Comparing with a carbon-based active material, a silicon-based active material possesses a larger theoretical capacity and a more moderate operating voltage.

The term “active material” as used herein means a material which is able to have lithium ions inserted therein and release lithium ion therefrom during repeated charging/discharging cycles.

There is no specific limitation to the silicon-based active material, and those which are known for use in lithium ion batteries may be used. In some examples, the silicon-based active material may be selected from the group consisting of silicon, silicon alloys and silicon/carbon composites. In some examples, the silicon alloy may comprise silicon and one or more metals selected from the group consisting of Ti, Sn, Al, Sb, Bi, As, Ge and Pb.

In some examples, the silicon-based active material may be in the form of powders, or may be ground into powders.

According to some examples of the present disclosure, the content of the silicon-based active material may be from 5% to 85% by weight, based on the total weight of the anode composition. For example, the content of the silicon-based active material may be about 5%, about 10%, about 15%, about 20%, about 25%, about 30%, about 35%, about 40%, about 45%, about 50%, about 55%, about 60%, about 65%, about 70, about 75%, about 80% and about 85% by weight, based on the total weight of the anode composition.

### Component b): Carboxyl-Containing Binder

According to some examples of the present disclosure, the anode composition may comprise a carboxyl-containing binder.

There is no specific limitation to the carboxyl-containing binder, and those which are known for use in lithium ion batteries may be used. In some examples, the carboxyl-containing binder may be a carboxylic acid, or a mixture of a carboxylic acid and its alkali metal salt, wherein the carboxylic acid may be selected from the group consisting of polyacrylic acid (PAA), carboxymethyl cellulose, alginic acid and xanthan gum. In some examples, the alkali metal salt may be selected from the group consisting of a lithium salt, sodium salt and potassium salt.

According to some examples of the present disclosure, the content of the carboxyl-containing binder may be from 5% by weight to 25% by weight, for example, from 10% by weight to 20% by weight (e.g. about 10%, about 15% and about 20% by weight), based on the total weight of the anode composition.

### Component c): Silane Coupling Agent

According to some examples of the present disclosure, the anode composition may comprise a silane coupling agent represented by the following formula (1):

Y—(CH₂)ₙ—Si—X3 (1)
wherein Y represents a non-hydrolytic group that is capable of forming a conductive polymer moiety upon polymerization;
X each independently represents a hydroxyl group, or a hydrolysable group selected from the group consisting of halogen atoms, alkoxy groups, ether groups and siloxy groups; and the three X groups may be identical with or different from each other; and
n represents an integer from 0 to 3.

In the context of the present disclosure, the term “non-hydrolytic group” means a group that does not hydrolyze to form a hydroxyl group when being brought into contact with water or a water-containing solvent.

In the context of the present disclosure, the term “hydrolysable group” means a group that is capable of hydrolyzing to form a hydroxyl group when being brought into contact with water or a water-containing solvent.

In the context of the present disclosure, each of the terms “alkyl group”, “alkoxy group”, “alkenyl group” and “alkynyl group” may independently represent a linear, branched or cyclic group, and may independently contain from 1 to 12 carbon atoms, for example, from 1 to 10 carbon atoms, from 1 to 8 carbon atoms or from 1 to 4 carbon atoms.

In the context of the present disclosure, each of the terms “aromatic group” and “aroxy group” may independently contain from 6 to 12 carbon atoms, for example, contain 6, 7, 8, 9, 10, 11 or 12 carbon atoms.

In some examples, X may independently be a hydroxyl group. In some examples, X may independently be a halogen atom, such as a fluorine atom, a chlorine atom, a bromine atom or an iodine atom. In some examples, X may independently be an alkoxy group, wherein the alkoxy group may have the same definition as mentioned above. In some examples, X may independently be an ether group, for example, an ether group having a structure represented by —O(CH₂)ₘOR′, wherein R′ may represent a hydrogen atom or an alkyl group, and the alkyl group may have the same definition as mentioned above; and m represents an integer from 0 to 4 (e.g., 0, 1, 2, 3 or 4). In some examples, X may independently be a siloxy group, for example, a siloxy group having a structure represented by —OSiR^{d}₃, wherein R^{d} each independently represents a hydrogen atom or an alkyl group, and the alkyl group may have the same definition as mentioned above. The three R^{d} groups in —OSiR^{d}₃ of the siloxy group may be identical with or different from each other.

In some examples, Y may comprise an aromatic conjugated moiety. In some examples, Y may be derived from aniline, pyrrole, thiophene and any combination thereof. In some examples, Y may be selected from the group consisting of

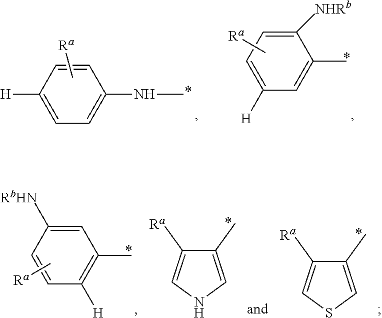

wherein * indicates the position where Y is linked to a moiety represented by —(CH₂)ₙ—Si—X₃ in the silane coupling agent; R^{a} and R^{b} each independently represents a hydrogen atom, or a substituent selected from the group consisting of alkyl groups, alkoxy groups, alkenyl groups, alkynyl groups, aromatic groups and aroxy groups. In some examples, Y group in formula (1) may represent H and/or

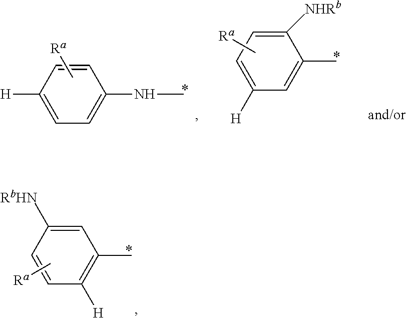

and in these cases, Y may be abbreviated as an “aniline-derived moiety”. In order to allow the “aniline-derived moiety” in the silane coupling agent to polymerize as expected, it is preferred that the para-position to “—NH—” or “—NHR^{b}” is occupied by hydrogen atom, rather than any substituent.

In some examples, Y group in formula (1) may represent

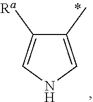

and in this case, Y may be abbreviated as a “pyrrole-derived moiety”. In some examples, Y group in formula (1) may represent

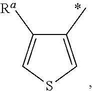

and in this case, Y may be abbreviated as a “thiophene-derived moiety”. In order to allow the “pyrrole-derived moiety” or “thiophene-derived moiety” in the silane coupling agent to polymerize as expected, it is preferred that the ortho-position to “—NH—” or to the sulfur atom is occupied by hydrogen atom, and a substituent (if any) may locate at a meta-position to “—NH—” or to the sulfur atom.

In the case where Y is

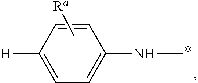

there may be one, two, three or four R^{a} groups altogether, and these R^{a} groups may be identical with or different from each other. In the case where Y is

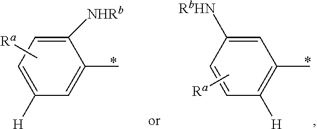

there may be one, two or three R^{a} groups altogether, and these R^{a} groups may be identical with or different from each other.

In some examples, in formula (1), X each independently is an alkoxy group, and Y is

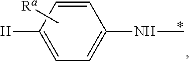

wherein the three X groups may be identical with or different from each other. In this case, the silane coupling agent may be represented by formula (2):

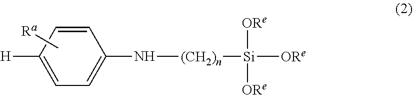

wherein R^{a} and n have the same definitions as those given for formula (1), R^{e} each independently represents an alkyl group, the alkyl group may have the same definition as mentioned above, and the three R^{e} groups may be identical with or different from each other.

Examples of the silane coupling agents represented by formula (2) may include, but not limited to, N-[(trimethoxysilyl)methyl]aniline, N-[(triethoxysilyl)methyl]aniline, N-[(trimethoxysilyl)ethyl]aniline, N-[(triethoxysilyl) ethyl]aniline, N-[3-(trimethoxysilyl)propyl]aniline and N-[3-(triethoxysilyl)propyl]aniline. For example, N-[(triethoxysilyl)methyl])aniline may be commercially available from Nanjing Diamond Chem Co. Ltd under the product name of ND42.

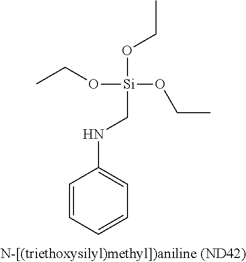 [SMILES: CCO[Si](CNc1ccccc1)(OCC)OCC]

According to some examples of the present disclosure, the weight ratio of the silane coupling agent to the silicon-based active material may be no less than 0.01:100 but less than 3:100, for example, from 0.01:100 to 2.5:100, from 0.01:100 to 2:100, from 0.1:100 to 1:100, or being about 0.5:100.

Although not intended to be bound by theories, it is presumed that the following reaction mechanisms apply to the silane coupling agent, the silicon-based active material and the carboxyl-containing binder according to the present disclosure.

### i) Hydrolysis of the Silane Coupling Agent

In the case where any one of the X groups in formula (1) represents a hydrolysable group, the hydrolysable group may hydrolyze upon contact with water or a water-containing solvent and thus form a hydroxyl group. The hydrolyzed product of the silane coupling agent may have a structure of silanol, for example, a completely hydrolyzed product of the silane coupling agent may be represented by Y—(CH₂)ₙ—Si—(OH)₃.

In the case where all of the three X groups in formula (1) represent hydroxyl groups, the silane coupling agent may be represented by Y—(CH₂)ₙ—Si—(OH)₃, therefore, the hydrolysis of the silane coupling agent may be omitted.

### ii) Reaction of Hydrolyzed Silane Coupling Agents Per Se, and Reaction Between the Hydrolyzed Silane Coupling Agent and the Silicon-Based Active Material

Since silicon has a high affinity for oxygen, an oxide layer will spontaneously form on the surface of silicon upon exposure to air even at room temperature. Therefore, there is usually a natural silicon oxide layer on the surface of the silicon-based active material. The surface layer of silicon oxide contains hydroxyl groups, i.e., silanol groups —Si—OH.

The hydroxyl groups contained in the hydrolyzed silane coupling agent (e.g., Y—(CH₂)ₙ—Si—(OH)₃) may condense with the hydroxyl groups on the surface of the silicon-based active material, with a water molecule being eliminated.

Condensation may also occur between the Si—OH groups in adjacent hydrolyzed silane coupling agents (e.g., Y—(CH₂)ₙ—Si—(OH)₃) per se, which enhances the crosslinking degree of the final polymerized product as mentioned below.

iii) Formation of a Conductive Polymer Moiety by Polymerization of the Aromatic Conjugated Moiety in the Silane Coupling Agent

The aromatic conjugated moiety (i.e., the Y group), such as the aniline-derived moiety, pyrrole-derived moiety and thiophene-derived moiety in the silane coupling agent may readily form an electrically conductive polymer moiety upon polymerization, and thus improve the electron conductivity and charge/discharge capacity of the whole anode, especially at high current density. The polymerization may be conducted by employing an oxidizing agent, or by exposing the silane coupling agent to ultraviolet irradiation and/or microwave irradiation.

### iv) Formation of a Three-Dimensional Conductive Network Through Reactions Between the Polymerized Silane Coupling Agent and the Carboxyl-Containing Binder

On the one hand, the —NH— group in the polyaniline moiety and polypyrrole moiety may react with the carboxyl group in the carboxyl-containing binder to form an amido group by eliminating a water molecule.

On the other hand, under an acidic condition provided by the carboxyl-containing binder, the π-conjugated system of the polyaniline moiety, polypyrrole moiety and the polythiophene moiety in the polymerized silane coupling agent may remove an electron to form a cation, which may also be referred to as “p-doping”. Meanwhile, the carboxyl-containing binder may accept an electron to form an anion. The cation and the anion thus generated may electrostatically combine together to form a salt.

For example, the polyaniline moiety may be p-doped and converted into a structure represented by

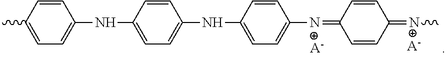

The polypyrrole moiety may be p-doped and converted into a structure represented by

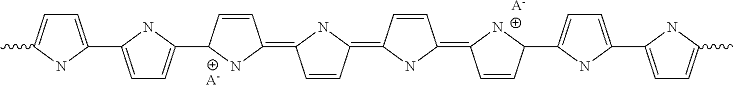

The polythiophene moiety may be p-doped and converted into a structure represented by

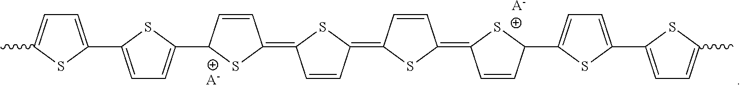

Herein, the wavy line “ [symbol] ” indicates the position where the p-doped polyaniline moiety, polypyrrole moiety or the polythiophene moiety is linked to the rest of the polymerized silane coupling agents. “⊕” indicates a p-doped position in the polyaniline moiety, polypyrrole moiety or the polythiophene moiety. “A⁻” represents an anion obtained from the carboxyl-containing binder by accepting an electron. Therefore, the polymerized and p-doped silane coupling agent may electrostatically connect with the carboxyl-containing binder.

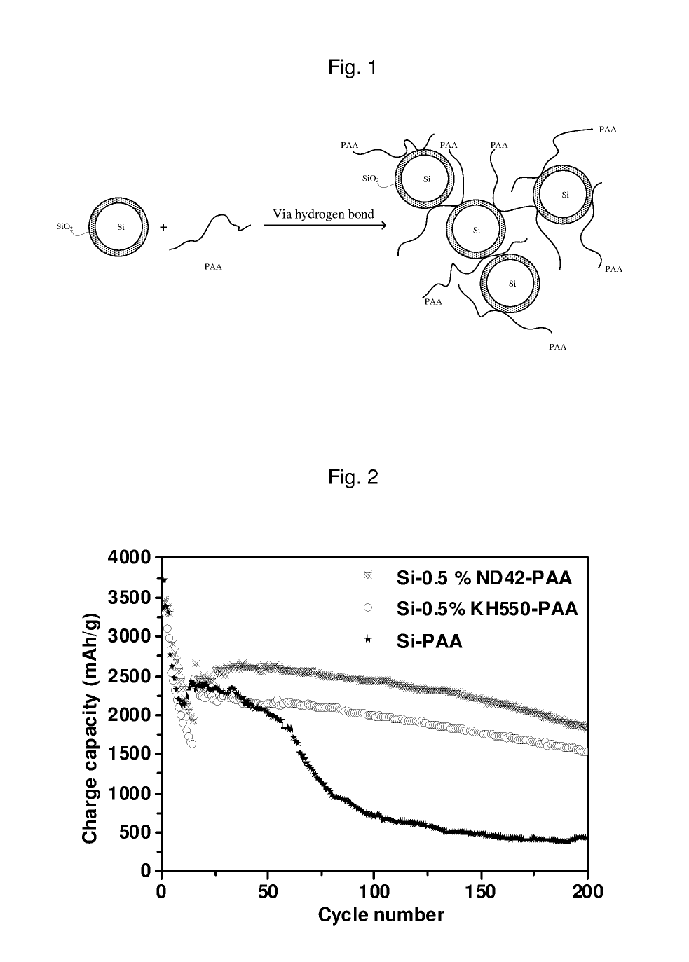

FIG. 1 (not drawn to scale) schematically illustrates a presumed bonding mechanism of an anode composition that contains silicon particles and polyacrylic acid, but does not contain a silane coupling agent. In the anode composition shown in FIG. 1, the silicon particles are connected together by hydrogen bonds between their surface hydroxyl groups and the carboxylic groups of the polyacrylic acid. However, the hydrogen bonds and a linear binding network thus formed are not strong enough to endure the volumetric change of the silicon particles during repeated charge/discharge cycles. Furthermore, the resultant binding network is not electrically conductive, which may inhibit electron transmission and impair electrochemical activity of the silicon particles.

Comparing with the anode composition shown in FIG. 1, the silane coupling agent in the anode composition according to the present disclosure may polymerize with itself, condense with itself, and react with the silicon-based active material and also with the carboxyl-containing binder, and thereby form a three-dimensional network through covalent bonds and electrostatic actions, which are stronger than hydrogen bonds. Furthermore, as mentioned above, the resultant three-dimensional network is electrically conductive, which may improve electron transmission and electrochemical activity of the silicon-based active material.

In contrast, when employing a silane coupling agent (such as KH-550, i.e. γ-aminopropyl triethoxysilane (NH₂C₃H₆Si(OC₂H₅)₃) that contains an aliphatic amino group or aliphatic imino group, but does not contain an aromatic conjugated moiety (such as a aniline-derived moiety, pyrrole-derived moiety and thiophene-derived moiety), an electronically insulative network is formed, which inhibits electron transmission and hinders the electrochemical activity of the silicon-based active material, and leads to a poor rate performance.

Therefore, the anode composition according to the present disclosure may impart excellent electrochemical properties, especially excellent cycling stability and rate performance to lithium ion batteries.

### Component d): Carbon Material

According to some examples of the present disclosure, the anode composition may optionally comprise a carbon material. The carbon material may increase the conductivity and/or capacity of the anode.

There is no specific limitation to the carbon material, and those which are known for use in lithium ion batteries may be used. In some examples, the carbon material may be selected from the group consisting of carbon black, super P, acetylene black, Ketjen black, graphite, graphene, carbon nanotubes and vapour grown carbon fibers. For example, super P may be commercially available from Timical.

In some examples, the carbon material may be in the form of powders, or may be ground into powders.

According to some examples of the present disclosure, the content of the carbon material may be from 0% by weight to 80% by weight, for example, from 5% by weight to 80% or from 20% by weight to 60% by weight, based on the total weight of the anode composition.

### Component e): Chain Extender

According to some examples of the present disclosure, the anode composition may optionally comprise component e): a chain extender. The chain extender may copolymerize with the aromatic conjugated moiety of the silane coupling agent, thereby allowing the polymer chain to propagate and enhance the electron conductivity of the whole anode.

In some examples, the chain extender may be selected from the group consisting of aniline, pyrrole, thiophene and their derivatives. In some examples, the chain extender corresponds to the aromatic conjugated moiety of the silane coupling agent. For example, in the case where an “aniline-derived moiety” is contained in the silane coupling agent, aniline or its derivative may be employed as chain extender. In the case where a “pyrrole-derived moiety” is contained in the silane coupling agent, pyrrole or its derivative may be employed as chain extender. In the case where a “thiophene-derived moiety” is contained in the silane coupling agent, thiophene or its derivative may be employed as chain extender.

According to some examples of the present disclosure, the content of the chain extender may be from 0 to 30% by weight, for example, about 5%, about 10%, about 15%, about 20%, about 25 or about 35%, based on the total weight of the anode composition.

### Preparation Process of an Anode

There is no specific limitation to the preparation process of the anode. In some examples, the process for preparing an anode may comprise:
preparing a slurry by mixing all components of the anode composition according to the present disclosure with water or a water-containing solvent;
allowing the silane coupling agent to polymerize so as to obtain a polymerized product; and
coating the polymerized product onto a current collector.

The term “water-containing solvent” as used in this disclosure means a solvent mixture contains water and a solvent other than water, such as a mixture of water and an alcohol.

In some examples, the polymerization is conducted by employing an oxidizing agent, or exposing the slurry to ultraviolet irradiation and/or microwave irradiation.

In some examples, the oxidizing agent may be selected from the group consisting of ammonium persulfate ((NH₄)₂S₂O₈), iron (III) chloride, copper (II) chloride, silver nitrate, hydrogen peroxide, chloroauric acid and ammonium cerium (IV) nitrate. For example, (NH₄)₂S₂O₈ may be commercially available from Sinopharm Chemical Reagent Co., Ltd. The oxidizing agent may also be removed, physically and/or chemically, after the silane coupling agent is polymerized.

In the case where an oxidizing agent is used, it may not only initiate the polymerization of the silane coupling agent, but also initiate the copolymerization of the chain extender (if any) with the silane coupling agent. The total amount of the oxidizing agent to be used is the sum of the amount of the oxidizing agent which the silane coupling agent needs to polymerize and the amount of the oxidizing agent which the chain extender (if any) needs to copolymerize. In some examples, the weight ratio of the silane coupling agent to the oxidizing agent needed by the silane coupling agent may vary from 1:1 to 4:1, for example, 1:1, 2:1, 3:1 or 4:1; and the weight ratio of the chain extender to the oxidizing agent needed by the chain extender is from 4:1 to 1:4, for example, 4:1, 3:1, 2:1 or 1:1.

### Lithium Ion Battery

The lithium ion battery according to the present invention may comprise an anode prepared from the anode composition according to the present disclosure, or comprising an anode prepared by the process according to the present disclosure.

The lithium ion batteries according to the present disclosure may be used in energy storage systems and electric vehicles.

In general, when the cathode efficiency is higher than the anode efficiency, a prelithiation can effectively increase the cell capacity via increasing the initial Coulombic efficiency. In this case, maximum energy density can be reached. For a cell, in which the loss of lithium during cycling may occur, prelithiation can also improve the cycling performance when an over-prelithiation is applied. The over-prelithiation provides a reservoir of lithium in the whole electrochemical system and the extra lithium in the anode compensates the possible lithium consumption from the cathode during cycling.

In principle, the higher prelithiation degree, the better cycling performance could be achieved. However, a higher prelithiation degree involves a much larger anode.

Therefore, the cell energy density will decrease due to the increased weight and volume of the anode. Therefore, the prelithiation degree should be carefully controlled to balance the cycling performance and the energy density.

The present invention, according to one aspect, relates to a lithium-ion battery comprising a cathode, an electrolyte, and an anode, wherein the anode is prepared from the anode composition according to the present disclosure, or prepared by the process according to the present disclosure, and the initial surface capacity a of the cathode and the initial surface capacity b of the anode satisfy the relation formulae

1<(b·(1−ε)/a)≤1.2 (I),

0<ε≤((a·η₁)/0.6−(a−b·(1−η₂)))/b (II),

where
ε is the prelithiation degree of the anode,
η₁ is the initial coulombic efficiency of the cathode, and
η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with an embodiment of the lithium-ion battery according to the present invention, the initial surface capacity a of the cathode and the initial surface capacity b of the anode satisfy the relation formulae

1.05≤(b·(1−ε)/a)≤1.15 (Ia),

preferably 1.08≤(b·(1−ε)/a)≤1.12 (Ib).

In accordance with another embodiment of the lithium-ion battery according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
c is the depth of discharge (DoD) of the anode.

In particular, ε=(b·(1−η₂)−a·(1−η₁))/b, when c=1.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

The present invention, according to another aspect, relates to a method for producing a lithium-ion battery comprising a cathode, an electrolyte, and an anode, wherein the anode is prepared from the anode composition according to the present disclosure, or prepared by the process according to the present disclosure, and said method includes the following steps:
1) prelithiating the active material of the anode or the anode to a prelithiation degree ε, and
2) assembling the anode and the cathode to obtain said lithium-ion battery, characterized in that the initial surface capacity a of the cathode, the initial surface capacity b of the anode, and the prelithiation degree ε satisfy the relation formulae

1<(b·(1−ε)/a)≤1.2 (I),

0<ε≤((a·η₁)/0.6−(a−b·(1−η₂)))/b (II),

where
ε is the prelithiation degree of the anode,
η₁ is the initial coulombic efficiency of the cathode, and
η₂ is the initial coulombic efficiency of the anode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

The prelithiation process is not particularly limited. The lithiation of the anode active material substrate can be carried out for example in several different ways. A physical process includes deposition of a lithium coating layer on the surface of the anode active material substrate such as silicon particles, thermally induced diffusion of lithium into the substrate such as silicon particles, or spray of stabilized Li powder onto the anode tape. An electrochemical process includes using silicon particles and a lithium metal plate as the electrodes, and applying an electrochemical potential so as to intercalate Li⁺ ions into the bulk of the silicon particles. An alternative electrochemical process includes assembling a half cell with silicon particles and Li metal foil electrodes, charging the half cell, and disassembling the half cell to obtain lithiated silicon particles.

In accordance with an embodiment of the method according to the present invention, the initial surface capacity a of the cathode and the initial surface capacity b of the anode satisfy the relation formulae

1.05≤(b·(1−ε)/a)≤1.15 (Ia),

preferably 1.08≤(b·(1−ε)/a)≤1.12 (Ib).

In accordance with another embodiment of the method according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
c is the depth of discharge (DoD) of the anode.

In particular, ε=(b·(1−η₂)−a·(1−η₁))/b, when c=1.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

Prior art prelithiation methods often involve a treatment of coated anode tape. This could be an electrochemical process, or physical contact of the anode with stabilized lithium metal powder. However, these prelithiation procedure requires additional steps to the current battery production method. Furthermore, due to the highly active nature of the prelithiated anode, the subsequent battery production procedure requires an environment with well-controlled humidity, which results in an increased cost for the cell production.

The present invention provides an alternative method of in-situ prelithiation. The lithium source for prelithaition comes from the cathode. During the first formation cycle, by increasing the cut-off voltage of the full cell, additional amount of lithium is extracted from the cathode; by controlling the discharge capacity, the additional lithium extracted from the cathode is stored at the anode, and this is ensured in the following cycles by maintaining the upper cut-off voltage the same as in the first cycle.

The present invention, according to another aspect, relates to a lithium-ion battery comprising a cathode, an electrolyte, and an anode, characterized in that the anode is prepared from the anode composition according to the present disclosure, or prepared by the process according to the present disclosure, and said lithium-ion battery is subjected to a formation process, wherein said formation process includes an initial formation cycle comprising the following steps:
a) charging the battery to a cut off voltage V_{off} which is greater than the nominal charge cut off voltage of the battery, and
b) discharging the battery to the nominal discharge cut off voltage of the battery.

In the context of the present invention, the term “formation process” means the initial one or more charging/discharging cycles of the lithium-ion battery for example at 0.1C, once the lithium-ion battery is assembled. During this process, a stable solid-electrolyte-inter-phase (SEI) layer can be formed at the anode.

In accordance with an embodiment of the formation process according to the present invention, in step a) the battery can be charged to a cut off voltage which is up to 0.8 V greater than the nominal charge cut off voltage of the battery, preferably 0.1˜0.5 V greater than the nominal charge cut off voltage of the battery, more preferably 0.2˜0.4 V greater than the nominal charge cut off voltage of the battery, particular preferably about 0.3 V greater than the nominal charge cut off voltage of the battery.

A lithium-ion battery with the typical cathode materials of cobalt, nickel, manganese and aluminum typically charges to 4.20V±50 mV as the nominal charge cut off voltage. Some nickel-based batteries charge to 4.10V±50 mV.

In accordance with another embodiment of the formation process according to the present invention, the nominal charge cut off voltage of the battery can be about 4.2 V±50 mV, and the nominal discharge cut off voltage of the battery can be about 2.5 V±50 mV.

In accordance with another embodiment of the formation process according to the present invention, the Coulombic efficiency of the cathode in the initial formation cycle can be 40%˜80%, preferably 50%˜70%.

In accordance with another embodiment of the formation process according to the present invention, said formation process further includes one or two or more formation cycles, which are carried out in the same way as the initial formation cycle.

For the traditional lithium-ion batteries, when the battery is charged to a cut off voltage greater than the nominal charge cut off voltage, metallic lithium will be plated on the anode, the cathode material becomes an oxidizing agent, produces carbon dioxide (CO₂), and increases the battery pressure.

In case of a preferred lithium-ion battery defined below according to the present invention, when the battery is charged to a cut off voltage greater than the nominal charge cut off voltage, additional Li⁺ ions can be intercalated into the anode having additional capacity, instead of being plated on the anode.

In case of another preferred lithium-ion battery defined below according to the present invention, in which the electrolyte comprises one or more fluorinated carbonate compounds as a nonaqueous organic solvent, the electrochemical window of the electrolyte can be broadened, and the safety of the battery can still be ensured at a charge cut off voltage of 5V or even higher.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the lithium-ion battery according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r=−0.75V_{off}−3.134 (V).

In accordance with another embodiment of the lithium-ion battery according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=−0.7857V_{off}²+7.6643V_{off}−18.33 (Va).

In accordance with another embodiment of the lithium-ion battery according to the present invention, the nominal initial surface capacity a of the cathode and the initial surface capacity b of the anode satisfy the relation formulae

1<b·η₂/(a·(1+r)−b·(1−η₂))−ε≤1.2 (I′),

preferably 1.05≤b·η₂/(a·(1+r)−b·(1−η₂))−ε≤1.15 (Ia′),

more preferably 1.08≤b·η₂/(a·(1+r)−b·(1−η₂))−ε≤1.12 (Ib′),

0<ε≤((a·η₁)/0.6−(a−b·(1−η₂)))/b (II),

where
ε is the prelithiation degree of the anode, and
η₂ is the initial coulombic efficiency of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the lithium-ion battery according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
η₁ is the initial coulombic efficiency of the cathode, and
c is the depth of discharge (DoD) of the anode.

In particular, ε=(b·(1−η₂)−a·(1−η₁))/b, when c=1.

In accordance with another embodiment of the lithium-ion battery according to the present invention, the electrolyte comprises one or more fluorinated carbonate compounds, preferably fluorinated cyclic or acyclic carbonate compounds, as a nonaqueous organic solvent.

In accordance with another embodiment of the lithium-ion battery according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the lithium-ion battery according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the lithium-ion battery according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the lithium-ion battery according to the present invention, the active material of the anode can be selected from the group consisting of carbon, silicon, silicon intermetallic compound, silicon oxide, silicon alloy and mixtures thereof.

In accordance with another embodiment of the lithium-ion battery according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

In accordance with another embodiment of the lithium-ion battery according to the present invention, after being subjected to the formation process, said lithium-ion battery can still be charged to a cut off voltage V_{off}, which is greater than the nominal charge cut off voltage of the battery, and be discharged to the nominal discharge cut off voltage of the battery.

In accordance with another embodiment of the lithium-ion battery according to the present invention, after being subjected to the formation process, said lithium-ion battery can still be charged to a cut off voltage V_{off}, which is up to 0.8 V greater than the nominal charge cut off voltage of the battery, more preferably 0.1˜0.5 V greater than the nominal charge cut off voltage of the battery, particular preferably 0.2˜0.4 V greater than the nominal charge cut off voltage of the battery, especially preferably about 0.3 V greater than the nominal charge cut off voltage of the battery, and be discharged to the nominal discharge cut off voltage of the battery.

The present invention, according to another aspect, relates to a method for producing a lithium-ion battery comprising a cathode, an electrolyte, and an anode, wherein the anode is prepared from the anode composition according to the present disclosure, or prepared by the process according to the present disclosure, and said method includes the following steps:
1) assembling the anode and the cathode to obtain said lithium-ion battery, and
2) subjecting said lithium-ion battery to a formation process, wherein said formation process includes an initial formation cycle comprising the following steps:
   a) charging the battery to a cut off voltage V_{off} which is greater than the nominal charge cut off voltage of the battery, and
   b) discharging the battery to the nominal discharge cut off voltage of the battery.

In the context of the present invention, the term “formation process” means the initial one or more charging/discharging cycles of the lithium-ion battery for example at 0.1C, once the lithium-ion battery is assembled. During this process, a stable solid-electrolyte-inter-phase (SEI) layer can be formed at the anode.

In accordance with an embodiment of the formation process according to the present invention, in step a) the battery can be charged to a cut off voltage which is up to 0.8 V greater than the nominal charge cut off voltage of the battery, preferably 0.1˜0.5 V greater than the nominal charge cut off voltage of the battery, more preferably 0.2˜0.4 V greater than the nominal charge cut off voltage of the battery, particular preferably about 0.3 V greater than the nominal charge cut off voltage of the battery.

A lithium-ion battery with the typical cathode materials of cobalt, nickel, manganese and aluminum typically charges to 4.20V±50 mV as the nominal charge cut off voltage. Some nickel-based batteries charge to 4.10V±50 mV.

In accordance with another embodiment of the formation process according to the present invention, the nominal charge cut off voltage of the battery can be about 4.2 V±50 mV, and the nominal discharge cut off voltage of the battery can be about 2.5 V±50 mV.

In accordance with another embodiment of the formation process according to the present invention, the Coulombic efficiency of the cathode in the initial formation cycle can be 40%˜80%, preferably 50%˜70%.

In accordance with another embodiment of the formation process according to the present invention, said formation process further includes one or two or more formation cycles, which are carried out in the same way as the initial formation cycle.

In order to implement the present invention, an additional cathode capacity can preferably be supplemented to the nominal initial surface capacity of the cathode.

In the context of the present invention, the term “nominal initial surface capacity” a of the cathode means the nominally designed initial surface capacity of the cathode.

In the context of the present invention, the term “surface capacity” means the specific surface capacity in mAh/cm², the electrode capacity per unit of the electrode surface area. The term “initial capacity of the cathode” means the initial delithiation capacity of the cathode, and the term “initial capacity of the anode” means the initial lithiation capacity of the anode.

In accordance with an embodiment of the method according to the present invention, the relative increment r of the initial surface capacity of the cathode over the nominal initial surface capacity a of the cathode and the cut off voltage V_{off} satisfy the following linear equation with a tolerance of ±5%, ±10%, or ±20%

r=−0.75V_{off}−3.134 (V).

In accordance with another embodiment of the method according to the present invention, the relative increment r of the initial surface capacity of the cathode over the nominal initial surface capacity a of the cathode and the cut off voltage V_{off} satisfy the following quadratic equation with a tolerance of ±5%, ±10%, or ±20%

r=−0.7857V_{off}²+7.6643V_{off}−18.33 (Va).

In accordance with another embodiment of the method according to the present invention, the nominal initial surface capacity a of the cathode and the initial surface capacity b of the anode satisfy the relation formulae

1<b·η₂/(a·(1+r)−b·(1−η₂))−ε≤1.2 (I′),

preferably 1.05≤b·η₂/(a·(1+r)−b·(1−η₂))−ε≤1.15 (Ia′),

more preferably 1.08≤b·η₂/(a·(1+r)−b·(1−η₂))−ε≤1.12 (Ib′),

0<ε≤((a·η₁)/0.6−(a−b·(1−η₂)))/b (II),

where
ε is the prelithiation degree of the anode, and
η₂ is the initial coulombic efficiency of the anode.

According to the present invention, the term “prelithiation degree” ε of the anode can be calculated by (b−a·x)/b, wherein x is the balance of the anode capacity after prelithiation and the cathode capacity. For safety reasons, the anode capacity is usually designed slightly greater than the cathode capacity, and the balance of the anode capacity after prelithiation and the cathode capacity can be selected from greater than 1 to 1.2, preferably from 1.05 to 1.15, more preferably from 1.08 to 1.12, particular preferably about 1.1.

In accordance with another embodiment of the method according to the present invention, the prelithiation degree of the anode can be defined as

ε=((a·η₁)/c−(a−b·(1−η₂)))/b (III),

0.6≤c<1 (IV),

preferably 0.7≤c<1 (IVa),

more preferably 0.7≤c≤0.9 (IVb),

particular preferably 0.75≤c≤0.85 (IVc),

where
η₁ is the initial coulombic efficiency of the cathode, and
c is the depth of discharge (DoD) of the anode.

In particular, c=(b·(1−η₂)−a·(1−η₁))/b, when c=1.

In accordance with another embodiment of the method according to the present invention, the electrolyte comprises one or more fluorinated carbonate compounds, preferably fluorinated cyclic or acyclic carbonate compounds, as a nonaqueous organic solvent.

In accordance with another embodiment of the method according to the present invention, the fluorinated carbonate compounds can be selected from the group consisting of fluorinated ethylene carbonate, fluorinated propylene carbonate, fluorinated dimethyl carbonate, fluorinated methyl ethyl carbonate, and fluorinated diethyl carbonate, in which the “fluorinated” carbonate compounds can be understood as “monofluorinated”, “difluorinated”, “trifluorinated”, “tetrafluorinated”, and “perfluorinated” carbonate compounds.

In accordance with another embodiment of the method according to the present invention, the fluorinated carbonate compounds can be selected from the group consisting of monofluoroethylene carbonate, 4,4-difluoro ethylene carbonate, 4,5-difluoro ethylene carbonate, 4,4,5-trifluoroethylene carbonate, 4,4,5,5-tetrafluoroethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4,4,5-trifluoro-5-methyl ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

In accordance with another embodiment of the method according to the present invention, the content of the fluorinated carbonate compounds can be 10˜100 vol. %, preferably 30˜100 vol. %, more preferably 50˜100 vol. %, particular preferably 80˜100 vol. %, based on the total nonaqueous organic solvent.

In accordance with another embodiment of the method according to the present invention, the active material of the anode can be selected from the group consisting of carbon, silicon, silicon intermetallic compound, silicon oxide, silicon alloy and mixtures thereof.

In accordance with another embodiment of the method according to the present invention, the active material of the cathode can be selected from the group consisting of lithium nickel oxide, lithium cobalt oxide, lithium manganese oxide, lithium nickel cobalt oxide, lithium nickel cobalt manganese oxide, and mixtures thereof.

### EXAMPLES

### Materials

Nano silicon particles: silicon-based active material, 50-200 nm, available from Alfa-Aesar.

Super P: carbon material, 40 nm, available from Timical.

PAA: polyacrylic acid, binder, Mv: ˜450 000, available from Aldrich.

ND42: N-[(triethoxysilyl)methyl])aniline, silane coupling agent containing an aromatic conjugated moiety, available from Nanjing Diamond Chem Co., Ltd.

KH550: γ-aminopropyl triethoxysilane, silane coupling agent containing no aromatic conjugated moiety, available from Sinopharm Chemical Reagent Co. Ltd.

(NH₄)₂S₂O₈: oxidizing agent, available from Sinopharm Chemical Reagent Co., Ltd.

Aniline: chain extender, available from Sinopharm Chemical Reagent Co. Ltd.

ET20-26: polyethylene (PE), separator, available from ENTEK.

### Example 1

### [Preparation of an Anode]

800 mg nano silicon particles were mixed with 100 mg Super P and 100 mg PAA in water to obtain a mixture. After stirring for 1 h, 4 mg ND42 was added into the mixture. Subsequently, the mixture was stirred for another 4 h, then 2 mg (NH₄)₂S₂O₈ was added into the mixture. After stirring for another 1 h, the resultant slurry was coated on a Cu foil, then dried at 70° C. in vacuum for 8 h. The coated Cu foil was cut into several Φ 12 mm anodes. Considering that the weight ratio of the silane coupling agent (ND 42) to the nano silicon particles was 0.5:100, the anode obtained from Example 1 is abbreviated to Si—0.5% ND42-PAA.

### [Preparation of a Cell]

A coin cell (CR2016) was assembled in an Argon-filled glovebox (MB-10 compact, MBraun) by using the anode obtained above. A Li metal foil was used as a counter electrode. 1M LiPF₆ in FEC/EC/DMC (1:5:5 by volume, a mixture of fluoroethylene carbonate (FEC), ethylene carbonate (EC) and dimethyl carbonate (DMC)) was used as an electrolyte. ET20-26 was employed as a separator.

### Example 2

A cell was prepared in the same way as described above for Example 1, except that 8 mg ND42 was used instead of 4 mg ND42 and 4 mg (NH₄)₂S₂O₈ was used instead of 2 mg (NH₄)₂S₂O₈. Considering that the weight ratio of the silane coupling agent (ND 42) to the nano silicon particles was 1:100, the anode obtained from Example 2 is abbreviated to Si-1% ND42-PAA.

### Example 3

A cell was prepared in the same way as described above for Example 1, except that 0.8 mg ND42 was used instead of 4 mg ND42 and 0.4 mg (NH₄)₂S₂O₈ was used instead of 2 mg (NH₄)₂S₂O₈. Considering that the weight ratio of the silane coupling agent (ND 42) to the nano silicon particles was 0.1:100, the anode obtained from Example 3 is abbreviated to Si—0.1% ND42-PAA.

### Example 4

A cell was prepared in the same way as described above for Example 1, except that 24 mg aniline was additionally added during preparation of the anode and 26 mg (NH₄)₂S₂O₈ was used instead of 2 mg (NH₄)₂S₂O₈. Here, 26 mg (NH₄)₂S₂O₈ was the sum of 2 mg (NH₄)₂S₂O₈ needed by ND42 and 24 mg (NH₄)₂S₂O₈ needed by aniline. Considering that the aniline copolymerized with ND42 to form a polyaniline (PANI)-ND42 copolymer, and that the weight ratio of the silane coupling agent (ND42): aniline: nano silicon particles was 0.5:3:100, the anode obtained from Example 4 is abbreviated to Si—0.5% ND42-3% PANI-PAA.

### Comparative Example 1

A cell was prepared in the same way as described above for Example 1, except that 4 mg KH550 was used instead of 4 mg ND42, and no (NH₄)₂S₂O₈ was used. Considering that the weight ratio of the silane coupling agent (KH550) to the nano silicon particles was 0.5:100, the anode obtained from Comparative Example 1 is abbreviated to Si—0.5% KH550-PAA.

### Comparative Example 2

A cell was prepared in the same way as described above for Example 1, except that neither silane coupling agent nor (NH₄)₂S₂O₈ was used. Hereinafter, the anode obtained from Comparative Example 2 is abbreviated to Si-PAA.

### Comparative Example 3

A cell was prepared in the same way as described above for Example 1, except that 24 mg ND42 was used instead of 4 mg ND42 and 12 mg (NH₄)₂S₂O₈ was used instead of 2 mg (NH₄)₂S₂O₈. Considering that the weight ratio of the silane coupling agent ND 42 to the nano silicon particles was 3:100, the anode obtained from Comparative Example 3 is abbreviated to Si-3% ND42-PAA.

### [Effects of Different Silane Coupling Agents]

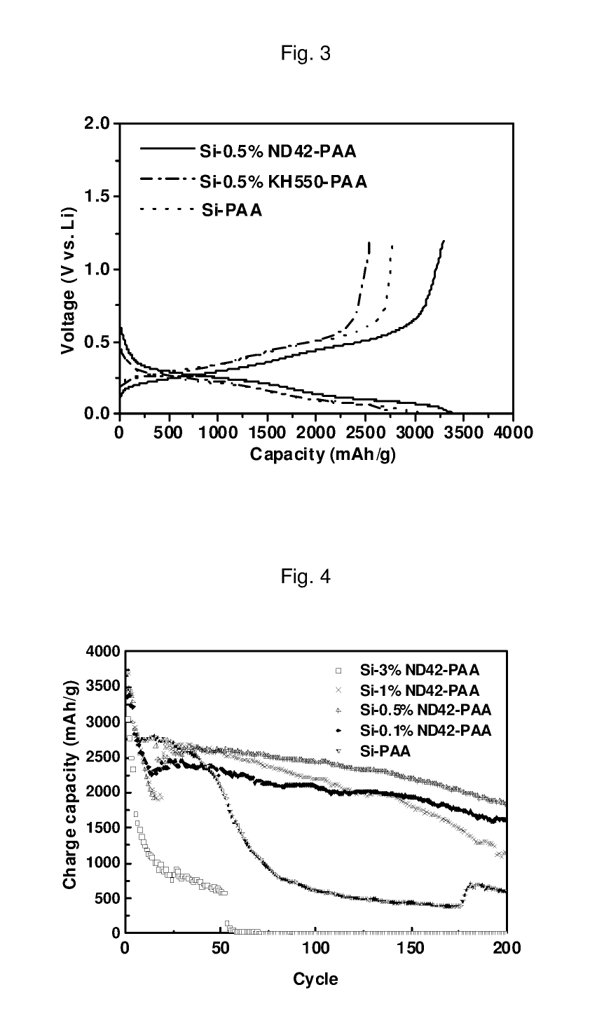

FIG. 2 compares the cycling performances of the cells of Example 1 (containing Si—0.5% ND42-PAA), Comparative Example 1 (containing Si—0.5% KH550-PAA) and Comparative Example 2 (containing Si-PAA without a silane coupling agent). FIG. 3 compares the discharge/charge profiles of these three cells at a high current density of 1.5 A g⁻¹.

The cycling performance of each cell was evaluated on a LAND battery test system (Wuhan Kingnuo Electronics Co., Ltd., China) at 25° C. Each cell was discharged/charged within a voltage range of from 0.01 to 1.2V (vs Li/Li⁺) and at 0.1 A g⁻¹ for the 1^{st} cycle, at 0.3 A g⁻¹ for the 2^{nd} and 3^{rd} cycles, and at a constant current density of 1.5 A g⁻¹ for the following cycles. The mass loading of the nano silicon particles in each anode of the cells is about 0.5 mg/cm².

The rate performance of each cell was evaluated on a LAND battery test system (Wuhan Kingnuo Electronics Co., Ltd., China) at 25° C. Each cell was discharged/charged within the voltage range of from 0.01 to 1.2V (vs Li/Li⁺⁾ at a constant current density of 1.5 A g⁻¹.

By referring to FIG. 2 and FIG. 3, it can be seen that Si—0.5% KH550-PAA and Si—0.5% ND42-PAA, which formed enhanced binding networks, showed better cycling performances than Si-PAA which only form hydrogen bonds. In addition, Si—0.5% ND42-PAA showed higher capacity than Si—0.5% KH550-PAA, especially at a high current density. What's more, compared with Si—0.5% KH550-PAA, Si—0.5% ND42-PAA showed lower charge voltage, higher discharge voltage and higher coulombic efficiency at a high current density of 1.5 A/g, as shown in FIG. 3. These results indicate that Si—0.5% ND42-PAA had a better rate capability owning to the conductive polymer layer formed on Si surface.

### [Effects of Different Contents of Silane Coupling Agents]

FIG. 4 compares the cycling performances of the cells of Example 1 (containing Si—0.5% ND42-PAA), Example 2 (containing Si-1% ND42-PAA), Example 3 (containing Si—0.1% ND42-PAA) with Comparative Example 2 (containing no silane coupling agent) and Comparative Example 3 (containing Si-3% ND42-PAA). The test condition of the cycling performance was the same as that mentioned above. By referring to FIG. 4, it can be seen that the cells according to Example 1, Example 2 and Example 3 exhibited excellent cycling stabilities.

### [Effect of a Chain Extender]

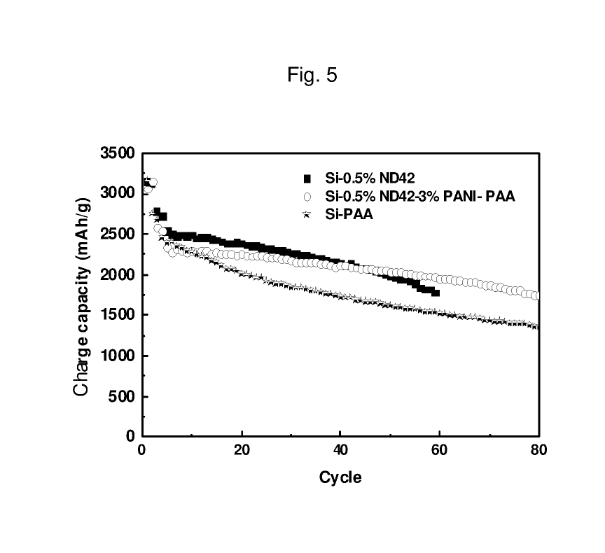

FIG. 5 compares the cycling performances the cells of Example 1 (containing Si—0.5% ND42-PAA), Example 4 (containing Si—0.5% ND42-3% PANI-PAA) and Comparative Example 2 (containing no silane coupling agent). Each cell was discharged/charged within a voltage range of from 0.01 to 1.2V (vs Li/Li⁺), and at 0.1 A g⁻¹ for the first two cycles and at 0.3 A g⁻¹ in the next two cycles, then discharged at 0.5 A/g and charged at 2.0 A/g for the following cycles. The mass loading of the nano silicon particles in each anode of the cells is about 0.5 mg/cm². By referring to FIG. 5, it can be seen that Si—0.5% ND42-PAA and Si—0.5% ND42-3% PANI-PAA showed much better cycling performances than Si-PAA due to the enhanced binding network. The cycling performance of Si—0.5% ND42-3% PANI-PAA was even better than Si—0.5% ND42-PAA owning to the addition of aniline, which allowed the conductive polymer chain to propagate.

### Examples P1 for Prelithiation

Active material of the cathode: NCM-111 from BASF, and HE-NCM prepared according to the method as described in WO 2013/097186 A1;
Active material of the anode: a mixture (1:1 by weight) of silicon nanoparticle with a diameter of 50 nm from Alfa Aesar and graphite from Shenzhen Kejingstar Technology Ltd.;
Carbon additives: flake graphite KS6L and Super P Carbon Black C₆₅ from Timcal;
Binder: PAA, Mv=450,000, from Sigma Aldrich;
Electrolyte: 1M LiPF₆/EC (ethylene carbonate)+DMC (dimethyl carbonate) (1:1 by volume);
Separator: PP/PE/PP membrane Celgard 2325.

### Example P1-E1

At first anode/Li half cells were assembled in form of 2016 coin cell in an Argon-filled glove box (MB-10 compact, MBraun), wherein lithium metal was used as the counter electrode. The assembled anode/Li half cells were discharged to the designed prelithiation degree ε as given in Table P1-E1, so as to put a certain amount of Li⁺ ions in the anode, i.e., the prelithiation of the anode. Then the half cells were disassembled. The prelithiated anode and NCM-111 cathode were assembled to obtain 2032 coin full cells. The cycling performances of the full cells were evaluated at 25° C. on an Arbin battery test system at 0.1C for formation and at 1C for cycling.

TABLE P1-E1

| Group | a | η₁ | b | η₂ | ε | c | x | η_{F} | Life |
|---|---|---|---|---|---|---|---|---|---|
| G0 | 2.30 | 90% | 2.49 | 87% | 0 | 1.00 | 1.08 | 83% | 339 |
| G1 | 2.30 | 90% | 2.68 | 87% | 5.6% | 0.99 | 1.10 | 86% | 353 |
| G2 | 2.30 | 90% | 3.14 | 87% | 19.5% | 0.83 | 1.10 | 89% | 616 |
| G3 | 2.30 | 90% | 3.34 | 87% | 24.3% | 0.77 | 1.10 | 88% | 904 |
| G4 | 2.30 | 90% | 3.86 | 87% | 34.6% | 0.66 | 1.10 | 89% | 1500 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

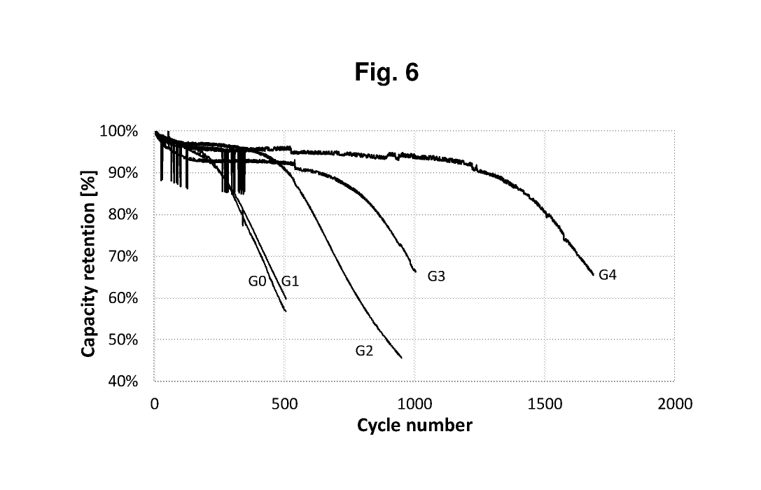

FIG. 6 shows the cycling performances of the full cells of Groups G0, G1, G2, G3, and G4 of Example P1-E1.

In case of Group G0 with a prelithiation degree E=0, the capacity of the full cell was decreased to 80% after 339 cycles.

In case of Group G1 with a prelithiation degree of 5.6%, the prelithiation amount was only enough to compensate the irreversible Li loss difference between the cathode and the anode. Therefore, the initial Coulombic efficiency was increased from 83% to 86%, while no obvious improvement in cycling performance was observed.

In case of Group G2 with a prelithiation degree increased to 19.5%, the prelithiation amount was not only enough to compensate the irreversible Li loss difference between the cathode and the anode, but also extra amount of Li was reserved in the anode to compensate the Li loss during cycling. Hence, the cycle life was greatly improved to 616 cycles.

In case of Groups G3 and G4 with further increased prelithiation degrees, more and more Li was reserved in the anode, so better and better cycling performances were obtained.

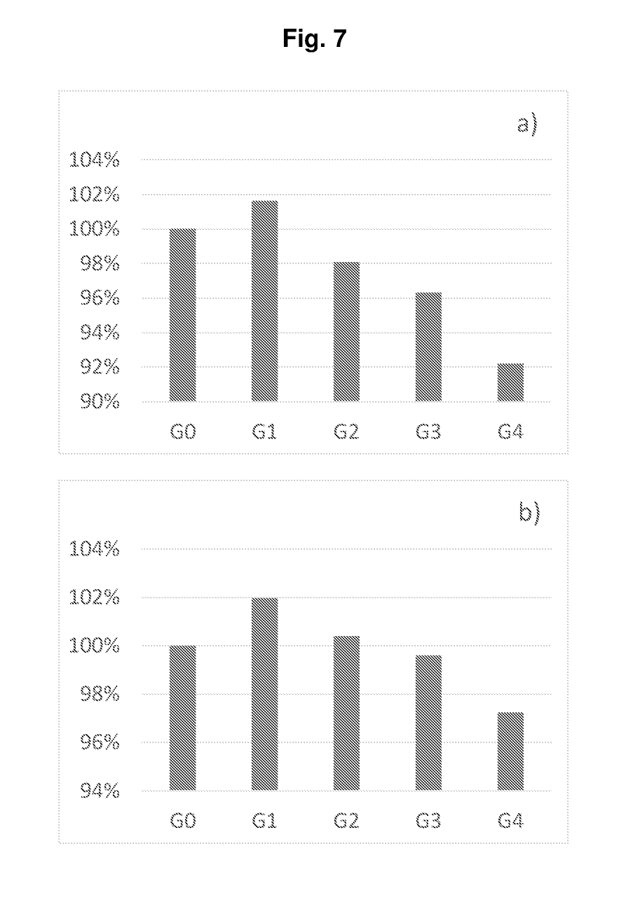

FIG. 7 shows a) the volumetric energy densities and b) the gravimetric energy densities of the full cells of Groups G0, G1, G2, G3, and G4 in Example P1-E1.

Compared with non-prelithiation (G0), Group G1 with 5.6% prelithiation degree shows a higher energy density due to the higher capacity. In case of the further increased prelithiation degree for a better cycling performance, the energy density decreases to some extend but still has more than 90% energy density of G0 when prelithiation degree reaches 34.6% in G4.

### Example P1-E2

Example P1-E2 was carried out similar to Example P1-E1, except that HE-NCM was used as the cathode active material and the corresponding parameters were given in Table P1-E2.

TABLE P1-E2

| Group | a | η₁ | b | η₂ | ε | c | x | η_{F} | Life |
|---|---|---|---|---|---|---|---|---|---|
| G0 | 3.04 | 96% | 3.25 | 87% | 0 | 1.00 | 1.07 | 85% | 136 |
| G1 | 3.04 | 96% | 4.09 | 87% | 18.3% | 0.90 | 1.10 | 94% | 231 |
| G2 | 3.04 | 96% | 4.46 | 87% | 26.3% | 0.80 | 1.08 | 95% | 316 |

a initial delithiation capacity of the cathode [mAh/cm²];
η₁ initial Coulombic efficency of the cathode;
b initial lithiation capacity of the anode [mAh/cm²];
η₂ initial Coulombic efficency of the anode;
ε prelithiation degree of the anode;
c depth of discharge of the anode;
x = b · (1 − ε)/a, balance of the anode and cathode capacities after prelithiation;
η_{F} initial Coulombic efficiency of the full cell;
Life cycle life of the full cell (80% capacity retention).

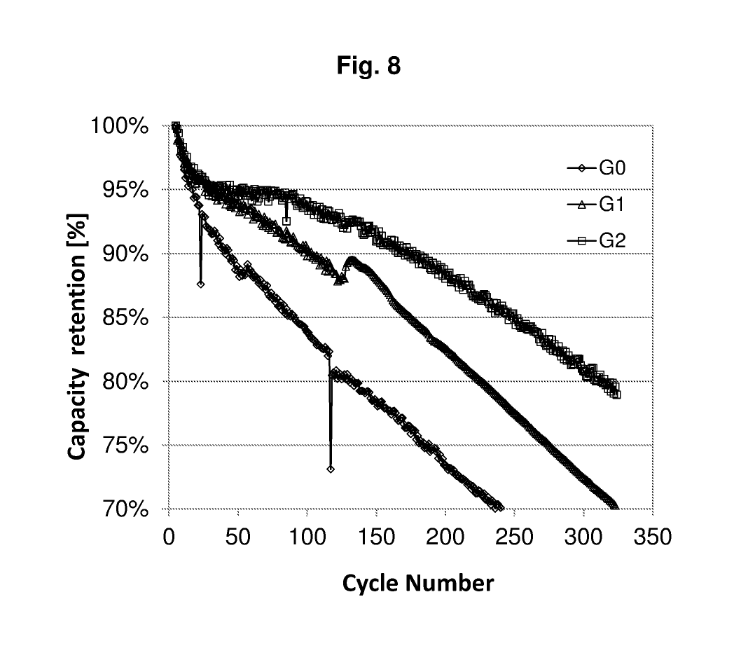

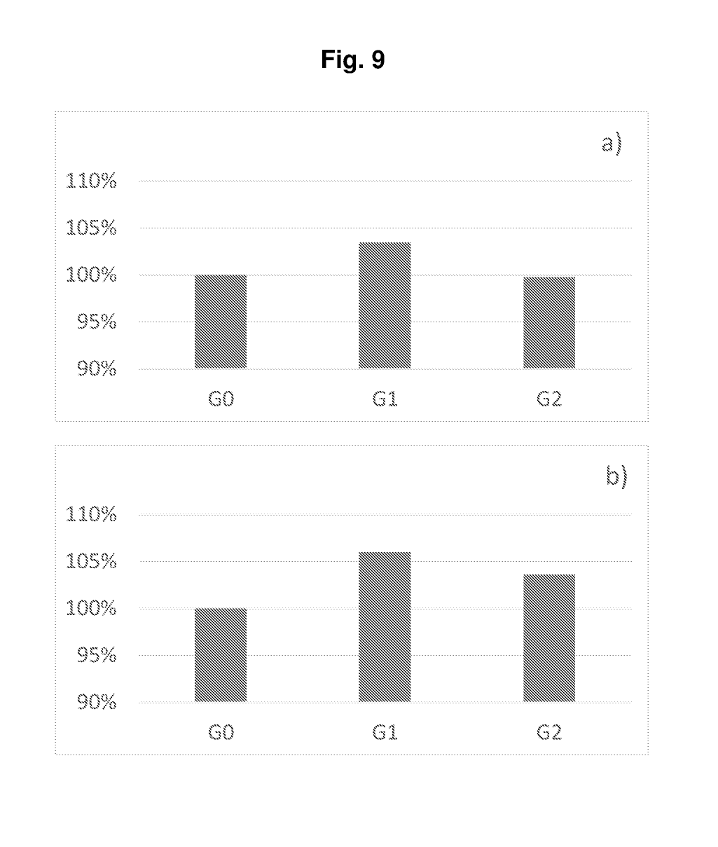

FIG. 8 shows the cycling performances of the full cells of Groups G0, G1, and G2 of Example P1-E2. FIG. 9 shows a) the volumetric energy densities and b) the gravimetric energy densities of the full cells of Groups G0, G1, and G2 of Example P1-E2. It can been seen from Table P1-E2 that the initial Coulombic efficiencies of the full cells were increased from 85% to 95% in case of the prelithiation. Although larger anodes were used for prelithiation, the energy density did not decrease, or even a higher energy density was reached, compared with non-prelithiation in G0. Moreover, the cycling performances were greatly improved, because the Li loss during cycling was compensated by the reserved Li.

### Example P1-E3

Example P1-E3 was carried out similar to Example P1-E1, except that pouch cells were assembled instead of coin cells, and the corresponding prelithiation degrees ε of the anode were a) 0 and b) 22%.

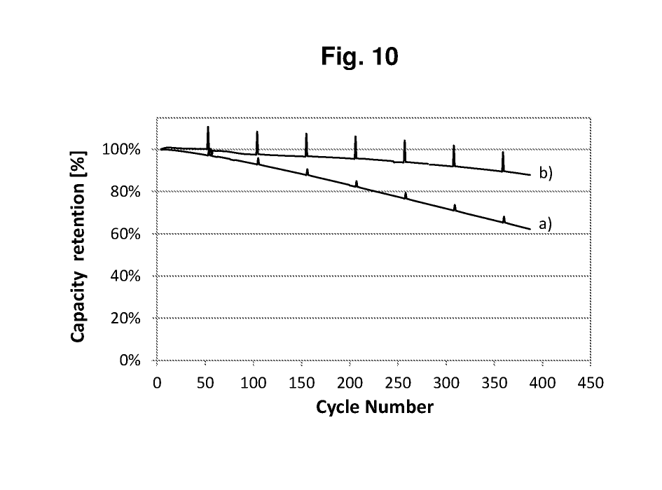

FIG. 10 shows the cycling performances of the full cells of Example P1-E3 with the prelithiation degrees ε of a) 0 and b) 22%. It can been seen that the cycling performance was much improved in case of the prelithiation.

### Examples P2 for Prelithiation

Size of the pouch cell: 46 mm×68 mm (cathode); 48 mm×71 mm (anode);
Cathode: 96.5 wt. % of NCM-111 from BASF, 2 wt. % of PVDF Solef 5130 from Sovey, 1 wt. % of Super P Carbon Black C₆₅ from Timcal, 0.5 wt. % of conductive graphite KS6L from Timcal;
Anode: 40 wt. % of Silicon from Alfa Aesar, 40 wt. % of graphite from BTR, 10 wt. % of NaPAA, 8 wt. % of conductive graphite KS6L from Timcal, 2 wt. % of Super P Carbon Black C₆₅ from Timcal;
Electrolyte: 1M LiPF₆/EC+DMC (1:1 by volume, ethylene carbonate (EC), dimethyl carbonate (DMC), including 30 vol. % of fluoroethylene carbonate (FEC), based on the total nonaqueous organic solvent);
Separator: PP/PE/PP membrane Celgard 2325.

### Comparative Example P2-CE1

A pouch cell was assembled with a cathode initial capacity of 3.83 mAh/cm² and an anode initial capacity of 4.36 mAh/cm² in an Argon-filled glove box (MB-10 compact, MBraun). The cycling performance was evaluated at 25° C. on an Arbin battery test system at 0.1C for formation and at 1C for cycling, wherein the cell was charged to the nominal charge cut off voltage 4.2 V, and discharged to the nominal discharge cut off voltage 2.5 V or to a cut off capacity of 3.1 mAh/cm². The calculated prelithiation degree ε of the anode was 0.

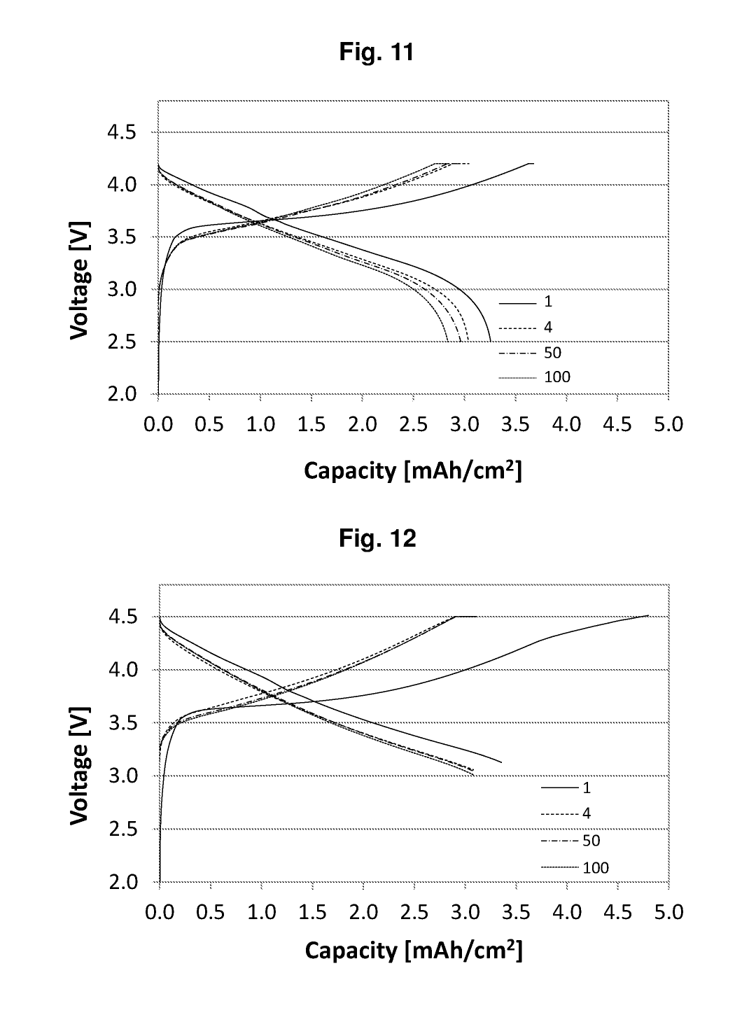

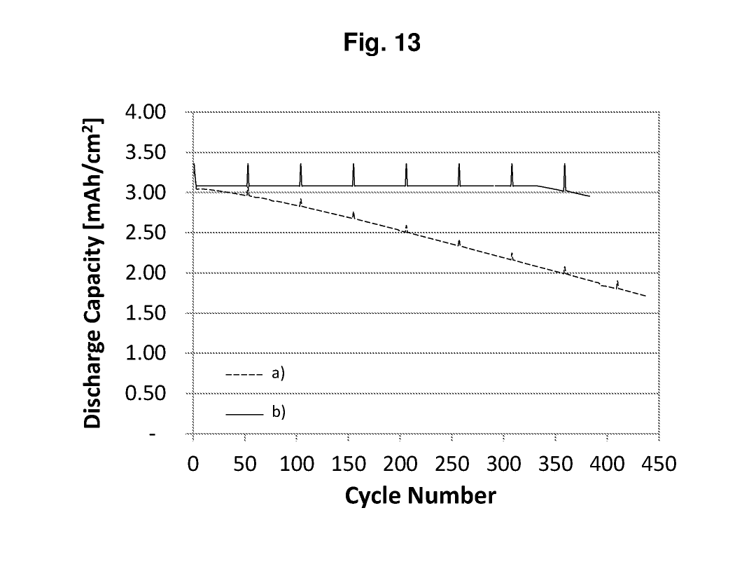

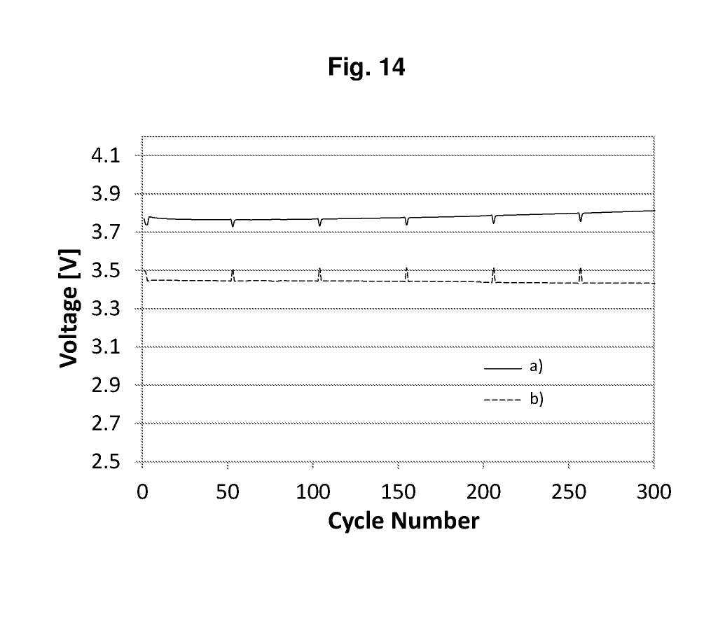

FIG. 11 shows the discharge/charge curve of the cell of Comparative Example P2-CE1, wherein “1”, “4”, “50” and “100” stand for the 1^{st}, 4^{th}, 50^{th} and 100^{th} cycle respectively. FIG. 13 shows the cycling performances of the cells of a) Comparative Example P2-CE1 (dashed line). FIG. 14 shows the average charge voltage a) and the average discharge voltage b) of the cell of Comparative Example P2-CE1.

### Example P2-E1

A pouch cell was assembled with a cathode initial capacity of 3.73 mAh/cm² and an anode initial capacity of 5.17 mAh/cm² in an Argon-filled glove box (MB-10 compact, MBraun). The cycling performance was evaluated at 25° C. on an Arbin battery test system at 0.1C for formation and at 1C for cycling, wherein the cell was charged to a cut off voltage of 4.5 V, which was 0.3 V greater than the nominal charge cut off voltage, and discharged to the nominal discharge cut off voltage 2.5 V or to a cut off capacity of 3.1 mAh/cm². The calculated prelithiation degree ε of the anode was 21%.

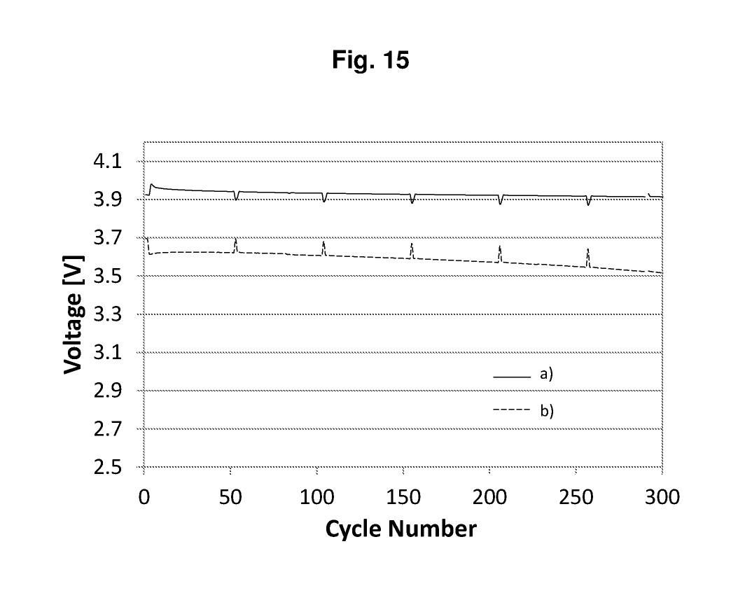

FIG. 12 shows the discharge/charge curve of the cell of Example P2-E1, wherein “1”, “4”, “50” and “100” stand for the 1^{st}, 4^{th}, 50^{th} and 100^{th} cycle respectively. FIG. 13 shows the cycling performances of the cells of b) Example P2-E1 (solid line). FIG. 15 shows the average charge voltage a) and the average discharge voltage b) of the cell of Example P2-E1.

While the disclosure has been described with reference to certain examples, those skilled in the art will appreciate that various modifications, changes, omissions, and substitutions can be made without departing from the spirit of the disclosure. It is intended, therefore, that the present disclosure be limited only by the scope of the following claims.

1. An anode composition for lithium ion batteries, comprising:
a) a silicon-based active material;
b) a carboxyl-containing binder; and
c) a silane coupling agent represented by the following formula (1):
Y—(CH₂)ₙ—Si—X3 (1)
wherein Y represents a non-hydrolytic group that is capable of forming a conductive polymer moiety upon polymerization;
X each independently represents a hydroxyl group, or a hydrolysable group selected from the group consisting of halogen atoms, alkoxy groups, ether groups and siloxy groups; and the three X groups may be identical with or different from each other; and
n represents an integer from 0 to 3.

2. The anode composition according to claim 1, wherein in formula (1), Y is derived from aniline, pyrrole, thiophene and any combination thereof; and Y is preferably selected from the group consisting of 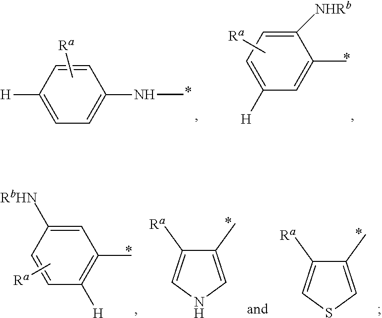
wherein * indicates the position where Y is linked to a moiety represented by —(CH₂)ₙ—Si—X3 in the silane coupling agent; and R^{a} and R^{b} each independently represents a hydrogen atom, or a substituent selected from the group consisting of alkyl groups, alkoxy groups, alkenyl groups, alkynyl groups, aromatic groups and aroxy groups.

3. The anode composition according to claim 1, wherein the silane coupling agent is represented by formula (2): 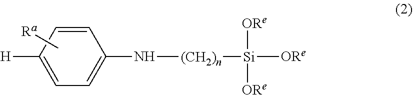
wherein R^{a} and n have the same definitions as those given for formula (1), R^{e} each independently represents an alkyl group, and the three R^{e} groups may be identical with or different from each other.

4. The anode composition according to claim 1, wherein the silicon-based active material is selected from the group consisting of silicon, silicon alloys and silicon/carbon composites.

5. The anode composition according to claim 1, wherein the carboxyl-containing binder is a carboxylic acid, or a mixture of a carboxylic acid and its alkali metal salt, wherein the carboxylic acid is preferably selected from the group consisting of polyacrylic acid, carboxymethyl cellulose, alginic acid and xanthan gum.

6. The anode composition according to claim 1, further comprising: d) a carbon material, wherein the carbon material is selected from the group consisting of carbon black, super P, acetylene black, Ketjen black, graphite, graphene, carbon nanotubes and vapour grown carbon fibers.

7. The anode composition according to claim 1, further comprising: e) a chain extender, which copolymerizes with the conductive polymer moiety obtainable from the silane coupling agent, and the chain extender is preferably selected from the group consisting of aniline, pyrrole, thiophene and their derivatives.

8. The anode composition according to claim 1, wherein the weight ratio of the silane coupling agent to the silicon-based active material is no less than 0.01:100 but less than 3:100.

9. The anode composition according to claim 8, comprising:
a) from 5% to 85% by weight of the silicon-based active material;
b) from 5% to 25% by weight of the carboxyl-containing binder;
c) the silane coupling agent;
d) from 0 to 80% by weight of carbon material; and
e) from 0 to 30% by weight of chain extender,
wherein the weight percents of components a), b), d) and e) are based on the total weight of the anode composition.

10. A process for preparing an anode for lithium ion batteries, comprising:
preparing a slurry by mixing all components of the anode composition according to claim 1 with water or a water-containing solvent;
allowing the silane coupling agent to polymerize so as to obtain a polymerized product; and
coating the polymerized product onto a current collector.

11. The process according to claim 10, wherein the polymerization is conducted by employing an oxidizing agent, or by exposing the slurry to ultraviolet irradiation and/or microwave irradiation.

12. The process according to claim 11, wherein the oxidizing agent is selected from the group consisting of ammonium persulfate, iron (III) chloride, copper (II) chloride, silver nitrate, hydrogen peroxide, chloroauric acid and ammonium cerium (IV) nitrate.

13. A lithium ion battery, comprising an anode prepared from the anode composition according to claim 1.

14. A lithium-ion battery comprising a cathode, an electrolyte, and an anode, wherein the anode is prepared from the anode composition according to claim 1, and the initial surface capacity a of the cathode and the initial surface capacity b of the anode satisfy the relation formulae
1<(b·(1−ε)/a)≤1.2 (I),
preferably 1.05≤(b·(1−ε)/a)≤1.15 (Ia),
more preferably 1.08≤(b·(1−ε)/a)≤1.12 (Ib),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

15. The lithium-ion battery of claim 14, characterized in that
ε=((a·η₁)/c−(a−b·(1−η₂)))/b (III),
0.6≤c<1 (IV),
preferably 0.7≤c<1 (IVa),
more preferably 0.7≤c≤0.9 (IVb),
particular preferably 0.75≤c≤0.85 (IVc),
where
c is the depth of discharge of the anode.

16. A method for producing a lithium-ion battery comprising a cathode, an electrolyte, and an anode, wherein the anode is prepared by the process according to claim 10, and said method includes the following steps:
1) prelithiating the active material of the anode or the anode to a prelithiation degree ε, and
2) assembling the anode and the cathode to obtain said lithium-ion battery, characterized in that the initial surface capacity a of the cathode, the initial surface capacity b of the anode, and the prelithiation degree ε satisfy the relation formulae
1<(b·(1−ε)/a)≤1.2 (I),
preferably 1.05≤(b·(1−ε)/a)≤1.15 (Ia),
more preferably 1.08≤(b·(1−ε)/a)≤1.12 (Ib),
0<ε≤((a·η₁)/0.6−(a−b·(1−η₂)))/b (II),
where
ε is the prelithiation degree of the anode,
η₁ is the initial coulombic efficiency of the cathode, and
η₂ is the initial coulombic efficiency of the anode.

17. The method of claim 16, characterized in that
ε=((a·η₁)/c−(a−b·(1−η₂)))/b (III),
0.6≤c<1 (IV),
preferably 0.7≤c<1 (IVa),
more preferably 0.7≤c≤0.9 (IVb),
particular preferably 0.75≤c≤0.85 (IVc),
where
c is the depth of discharge of the anode.

18-24. (canceled)

25. A method for producing a lithium-ion battery comprising a cathode, an electrolyte, and an anode, wherein the anode is prepared the process according to claim 10, and said method includes the following steps:
1) assembling the anode and the cathode to obtain said lithium-ion battery, and
2) subjecting said lithium-ion battery to a formation process, wherein said formation process includes an initial formation cycle comprising the following steps:
a) charging the battery to a cut off voltage V_{off} which is greater than the nominal charge cut off voltage of the battery, preferably up to 0.8 V greater than the nominal charge cut off voltage of the battery, more preferably 0.1˜0.5 V greater than the nominal charge cut off voltage of the battery, particular preferably 0.2˜0.4 V greater than the nominal charge cut off voltage of the battery, especially preferably about 0.3 V greater than the nominal charge cut off voltage of the battery, and
b) discharging the battery to the nominal discharge cut off voltage of the battery.

26. The method of claim 25, characterized in that the relative increment r of the initial surface capacity of the cathode over the nominal initial surface capacity a of the cathode and the cut off voltage V_{off} satisfy the following linear equation with a tolerance of ±10%
r=−0.75V_{off}−3.134 (V).

27. The method of claim 25, characterized in that the relative increment r of the initial surface capacity of the cathode over the nominal initial surface capacity a of the cathode and the cut off voltage V_{off} satisfy the following quadratic equation with a tolerance of ±10%
r=−0.7857V_{off}²+7.6643V_{off}−18.33 (Va).

28. The method of claim 25, characterized in that the nominal initial surface capacity a of the cathode and the initial surface capacity b of the anode satisfy the relation formulae
1<b·η₂/(a·(1+r)−b·(1−η₂))−ε≤1.2 (I′),
preferably 1.05≤b·η₂/(a·(1+r)−b·(1−η₂))−ε≤1.15 (Ia′),
more preferably 1.08≤b·η₂/(a·(1+r)−b·(1−η₂))−ε≤1.12 (Ib′),
0<ε≤((a·η₁)/0.6−(a−b·(1−η₂)))/b (II),
where
ε is the prelithiation degree of the anode, and
η₂ is the initial coulombic efficiency of the anode.

29. The method of claim 25, characterized in that
ε=((a·η₁)/c−(a−b·(1−η₂)))/b (III),
0.6≤c<1 (IV),
preferably 0.7≤c<1 (IVa),
more preferably 0.7≤c≤0.9 (IVb),
particular preferably 0.75≤c≤0.85 (IVc),
where
η₁ is the initial coulombic efficiency of the cathode, and
c is the depth of discharge of the anode.

30. The method of claim 25, characterized in that the electrolyte comprises one or more fluorinated carbonate compounds, preferably fluorinated cyclic or acyclic carbonate compounds, as a nonaqueous organic solvent.
